(19) United States
(12) Patent Application Publication
(10) Pub. No.: US 2011/0284666 A1
(43) Pub. Date: Nov. 24, 2011

(54) LASER WELDING METHOD AND PIPE JOINT PRODUCT JOINED BY THE METHOD

(75) Inventors: Koichi SUGIYAMA, Nagoya-city (JP); Hisatoshi TSUKAHARA, Okazaki-city (JP); Shinichirou NEZAKI, Nishio-city (JP); Makoto TAKEUCHI, Obu-city (JP); Mitsuya SUZUKI, Kariya-city (JP)

(73) Assignee: DENSO CORPORATION, Kariya-city (JP)

(21) Appl. No.: 13/112,383

(22) Filed: May 20, 2011

(30) Foreign Application Priority Data
May 20, 2010 (JP) 2010-116253

(51) Int. Cl. F02M 63/00; B32B 1/08; B23K 26/00

(52) U.S. Cl. 239/533.2; 219/121.64; 428/686

(57) ABSTRACT

According to a laser welding method, an inert gas injection process and welding process are performed. In the inert gas injection process, inert gas is injected into an inside of a first metal pipe; and air inside the first pipe is discharged into the outside. In the welding process, a second metal pipe is irradiated with a laser from radially outward of the second pipe; metal is melted with a penetration depth of a penetration part adjusted such that a leading end of the penetration part is located within thickness of the first pipe; and the first and second pipes are welded together along the circumferential direction to form a pipe joint product. An inner wall of the first pipe maintains its pre-welding metallic luster. An injector includes an injection nozzle, a fuel passage member, a valve member accommodated in the fuel passage member, and a driving unit driving the valve member. The fuel passage member is welded as the first pipe by the laser welding method to maintain pre-welding metallic luster on an inner wall of the fuel passage member.

### CROSS REFERENCE TO RELATED APPLICATION

This application is based on and incorporates herein by reference Japanese Patent Application No. 2010-116253 filed on May 20, 2010.

### BACKGROUND OF THE INVENTION

1. Field of the Invention

The present invention relates to a laser welding method applied to overlap welding of thin-walled metal pipes, and a pipe joint product joined by this method.

2. Description of Related Art

Conventionally, a laser light having high energy and good directivity is used for precise welding of a metal member, for instance. A laser welding method suitable for welding of a stainless steel pipe or a steel-sheet end face, and a method for limiting generation of a defect such as air bubbles in the laser welding, are disclosed in, for example, JP-A-H08-132262, JP-A-H09-295011, and JP-A-2001-205464.

In an injector that is used for a fuel injection system in, for example, an internal combustion engine for a vehicle, since a fuel passage member is generally formed into a thin-walled pipe shape, it is effective to use laser welding for a precise jointing between the fuel passage member and a fitted part of an injection nozzle, for example. For example, a method for preventing welding distortion, for instance, in the laser welding of the injector is disclosed in JP-A-H11-270439 and JP-A-2002-317728.

Generally, in the laser welding, an “irradiated side member” is overlapped with a “melted side member”, and the irradiated side member is irradiated with a laser. Accordingly, metal is made to melt from the irradiated side member into the melted side member. By controlling an energy value and irradiation time of the laser with which the member is irradiated, depth and width of weld penetration from the irradiated side member into the melted side member are controlled. When pipes are fitted together and their overlapping portion is welded, an inner pipe corresponds to the “melted side member”, and an outer pipe corresponds to the “irradiated side member.” Metal is melted, spanned between an inner wall of the outer pipe and an outer wall of the inner pipe. In a product for which a high level of quality is required with respect to, for example, surface roughness of an inner wall of the inner pipe, such as an injector, it is desirable that the weld penetration depth should be adjusted such that reach of a weld penetration part to the inner wall of the inner pipe is avoided and a front end of the weld penetration part is located within thickness of the inner pipe.

However, heat capacity that a member of the thin-walled pipe can be received is small, and temperature of the member at the time of welding is easily influenced by its environmental temperature. Accordingly, temperature of the weld penetration part is not stabilized, and it is difficult to accurately control the penetration depth only through the control of the energy value and irradiation time of the laser with which the member is irradiated. If the weld penetration depth is great, a “penetration” defect that the leading end of the weld penetration part passes through the inner wall of the inner pipe may be caused. Moreover, sputters may be produced on the inner wall of the inner pipe due to the “penetration”. As described above, there is a problem that welding quality becomes poor.

### SUMMARY OF THE INVENTION

The present invention addresses at least one of the above disadvantages.

According to the present invention, there is provided a laser welding method for forming a pipe joint product. According to the laser welding method, a first pipe made of metal is provided. A second pipe is fitted on a radially outward part of the first pipe. The second pipe is made of metal. An inert gas injection process is performed. At the time of performing the inert gas injection process, inert gas is injected into an inside of the first pipe; air in the inside of the first pipe is discharged into an outside of the first pipe; and a welding process is performed. At the time of performing the welding process, the second pipe is irradiated with a laser from radially outward of the second pipe; metal is melted from the second pipe into the first pipe, with a weld penetration depth of a weld penetration part of the second pipe into the first pipe being adjusted such that a leading end of the penetration part is located within a thickness of the first pipe; and the first pipe and the second pipe are welded together along a circumferential direction thereof so as to form the pipe joint product.

Moreover, to achieve the objective of the present invention, there is provided a laser welding method for forming a pipe joint product. According to the laser welding method, a first pipe made of metal is provided. A second pipe is fitted on a radially outward part of the first pipe. The second pipe is made of metal. A low pressure welding process is performed. At the time of performing the low pressure welding process, a pressure of an inside of the first pipe is made lower than atmospheric pressure; the second pipe is irradiated with a laser from radially outward of the second pipe; metal is melted from the second pipe into the first pipe, with a weld penetration depth of a weld penetration part of the second pipe into the first pipe being adjusted such that a leading end of the penetration part is located within a thickness of the first pipe; and the first pipe and the second pipe are welded together along a circumferential direction thereof so as to form the pipe joint product.

To achieve the objective of the present invention, there is also provided a pipe joint product formed by the laser welding method. An inner wall of the first pipe maintains its pre-welding metallic luster.

To achieve the objective of the present invention, there is further provided an injector adapted for a fuel injection system of an internal combustion engine. The injector includes an injection nozzle, a fuel passage member, a valve member, and a driving unit. The injection nozzle is configured to inject fuel. The fuel passage member defines a fuel passage communicating with the injection nozzle, and is welded as the first pipe by the laser welding method to maintain pre-welding metallic luster on an inner wall of the fuel passage member. The valve member is accommodated in the fuel passage member to reciprocate therein so as to open or close the injection nozzle. The driving unit is configured to drive the valve member.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view illustrating a laser welding method in accordance with a first embodiment of the invention;

FIG. 2A is an enlarged view illustrating a main feature in FIG. 1;

FIG. 2B is a main feature enlarged view illustrating a laser welding method in accordance with a comparative example;

FIG. 3 is a schematic view illustrating a laser welding method in accordance with a second embodiment of the invention;

FIG. 4A is a schematic view illustrating a housing assembly of an injector in accordance with a third embodiment of the invention;

FIG. 4B is an enlarged view illustrating a front end portion of the housing assembly in FIG. 4A;

FIG. 5 is a schematic view illustrating a main feature of the injector in accordance with the third embodiment;

FIG. 6 is a schematic view illustrating a housing assembly of an injector in accordance with a fourth embodiment of the invention; and

FIG. 7 is a schematic view illustrating a laser welding method in accordance with another embodiment of the invention.

### DETAILED DESCRIPTION OF THE INVENTION

A laser welding method in accordance with embodiments of the invention will be described below with reference to the accompanying drawings.

### First Embodiment

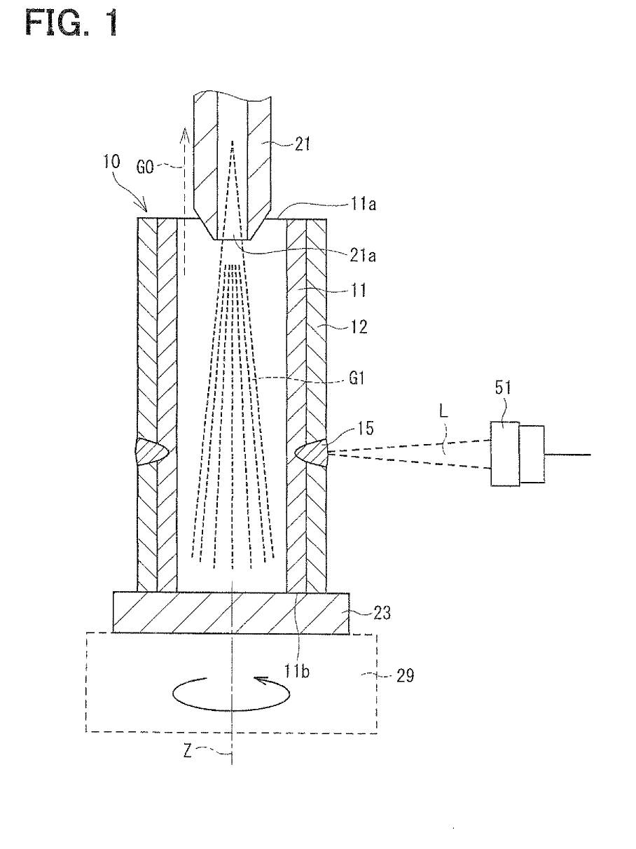

A laser welding method of a first embodiment of the invention is, as illustrated in FIG. 1, a method for forming a pipe joint product 10 by welding together a first metal pipe 11, and a second metal pipe 12 that is fitted into a radially outward part of the first pipe 11. The first pipe 11 corresponds to a “melted side member”, and the second pipe 12 corresponds to an “irradiated side member”. In the following description, explanation will be given with an upper side in FIG. 1 referred to as “up”, and a lower side in FIG. 1 as “down”.

The first pipe 11 is disposed with its lower end surface 11b in contact with a tabular jig 23 for gas retention. The jig 23 for gas retention may correspond to a “covering member”. The second pipe 12 has approximately the same length as the first pipe 11, and an inner diameter of the second pipe 12 is slightly larger than an outer diameter of the first pipe 11. The second metal pipe 12 is fitted into the radially outward part of the first pipe 11. The jig 23 is disposed on a rotatable table 29. A rotation axis Z of the rotatable table 29 generally coincidences with a central axis of the first pipe 11. A leading end of a gas injection nozzle 21 is inserted into an upper opening 11a of the first pipe 11.

The laser welding method includes an inert gas injection process, a welding process, and a cooling process. In the inert gas injection process, inert gas G1 is injected into the inside of the first pipe 11 through a nozzle hole 21a of the gas injection nozzle 21. Meanwhile, air G0 that has been inside the first pipe 11 is discharged from the opening 11a. The inert gas G1 is for example, nitrogen, argon, helium.

In the welding process, the rotatable table 29 and the jig 23 are rotated at a predetermined speed around the rotation axis Z, and the first pipe 11 and the second pipe 12 are accordingly rotated around their central axis. Then, an outer peripheral surface of the second pipe 12 is irradiated from a laser irradiation head 51 with a laser light L, with the first pipe 11 and the second pipe 12 rotated, and metal is thereby melted into the first pipe 11 from the second pipe 12. Meanwhile, an energy value and irradiation time of the laser irradiation are adjusted such that a leading end of a weld penetration part 15 is located within thickness of the first pipe 11. In the welding process, for example, by performing the welding upon the first pipe and the second pipe with the first and second pipes rotated around their central axis, welding that is even along their whole circumference is made possible. In the cooling process, a place welded in the welding process is cooled by the inert gas G1 that continues to be injected from the inert gas injection process. Because temperature of the inert gas G1 is lower than the atmospheric temperature, cooling efficiency is made good, so that a cooling time can be shortened. After the welding process, in a period during which the temperature of the welded place is comparatively high, a state, in which the inner wall of the first pipe is easily oxidized upon contact of oxygen therewith, continues. The temperature of the welded place is promptly reduced in the cooling process, so that the oxidation of the inner wall of the first pipe can be more reliably prevented. By injecting the inert gas continuously after the welding process, another coolant gas or the like does not need to be used exclusively for the cooling process, and the cooling process can be carried out efficiently.

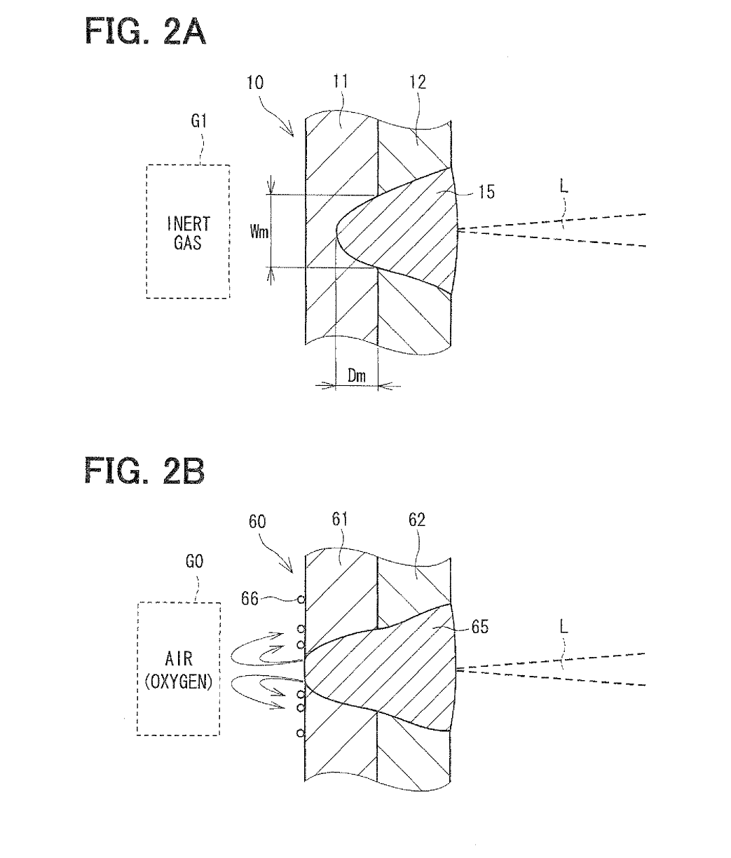

An effect of the laser welding method of the first embodiment of the invention will be described in reference with FIG. 2A. Oxidation of an inner wall of the first pipe 11 is prevented as a result of the injection of inert gas into the inside of the first pipe 11. Because the inert gas cools the inner wall of the first pipe 11, temperature of the weld penetration part 15 is stabilized. Accordingly, a weld penetration depth Dm or a weld penetration width Wm can be accurately controlled such that the leading end of the weld penetration part 15 is located within the thickness of the first pipe 11. Therefore, a penetration defect or generation of sputters is prevented, so that the welding quality of the pipe joint product 10 can be improved.

By the laser welding method of the first embodiment, the inner wall of the first pipe 11, which is the melted side member is not burned or oxidized, and its metallic luster before welding is maintained. Accordingly, it is determined that the pipe joint product 10 produced by the laser welding method of the invention through the observation of the inner wall of the first pipe 11. If the end portion of the first pipe or the second pipe on the opposite side from the inert gas injection-side is open, a ratio of the inert gas that is not accumulated inside the first pipe so as to flow out to the entire injected inert gas becomes high. Accordingly, by covering the end portion on the opposite side from the inert gas injection-side, the inert gas can be efficiently accumulated inside the first pipe. “Metallic luster before welding being maintained” means that there is no “burn” or discoloration due to oxidation. By the laser welding method of the invention, temperature of the weld penetration part is stabilized, and the weld penetration depth can be accurately controlled such that the front end of the weld penetration part is located within the thickness of the first pipe. Accordingly, the inner wall of the first pipe is not burned or oxidized.

Next, a laser welding method in accordance with a comparative example will be described. As illustrated in FIG. 2B, a pipe joint product 60 of the comparative example is laser-welded in the atmosphere. Oxygen exists radially inward of a first pipe 61, and oxidation of an inner wall of the first pipe 61 is easily caused by heat due to laser irradiation. Since the inner wall of the first pipe 61 is not cooled, temperature of a weld penetration part 65 continues rising. Accordingly, the temperature of the weld penetration part 65 is not stabilized, and it is difficult to accurately control a weld penetration depth only through the control of the energy value and irradiation time of a laser with which a second pipe 62 is irradiated. If the penetration depth is large, a “penetration” defect of a leading end of the weld penetration part 65 passing through the inner wall of the first pipe 61 is caused, or a sputter 66 is produced on the inner wall of the first pipe 61 due to the “penetration”. As a result, welding quality of the pipe joint product 60 becomes poor.

### Second Embodiment

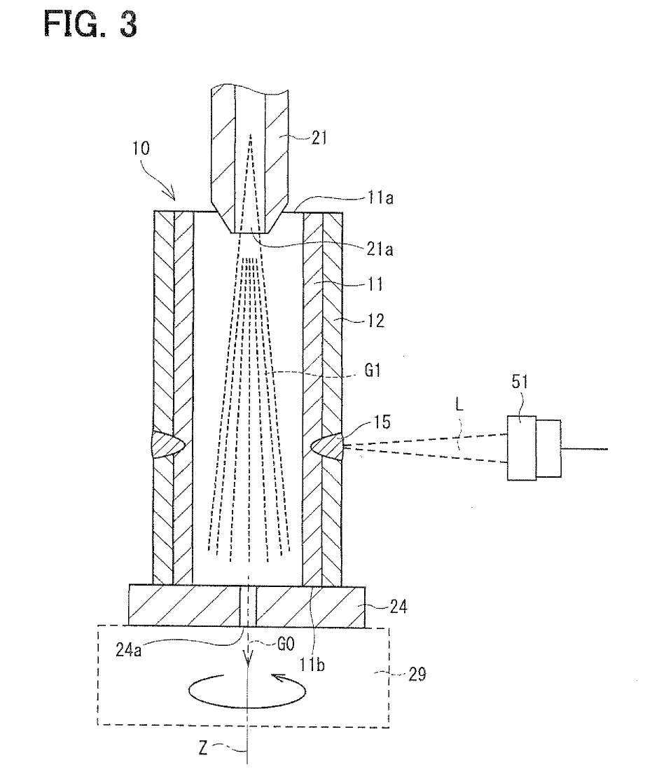

A second embodiment of the invention will be described with reference to FIG. 3. The same numerals are used for indicating substantially the same components as the first embodiment, and their descriptions are omitted. In the second embodiment, a jig 24 for gas retention having an air vent 24a is used as the covering member. Accordingly, air G0 that has been inside a first pipe 11 is discharged through the air vent 24a as a result of the injection of inert gas G1 from a gas injection nozzle 21. Thus, the air G0 can be efficiently replaced with the inert gas G1 in a short time.

### Third Embodiment

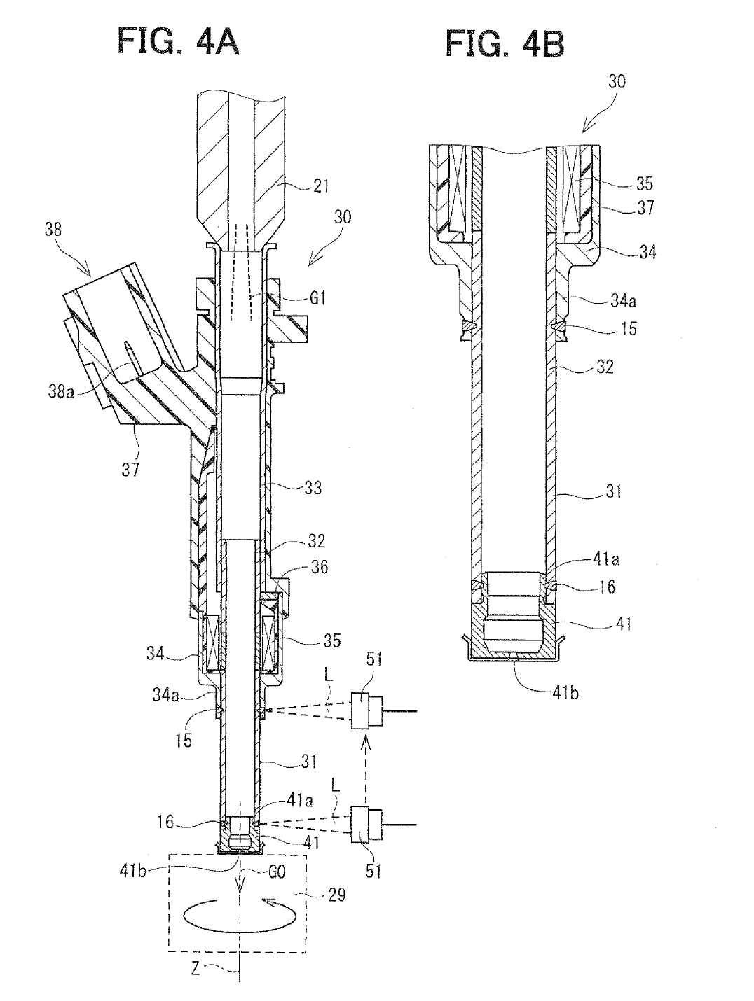

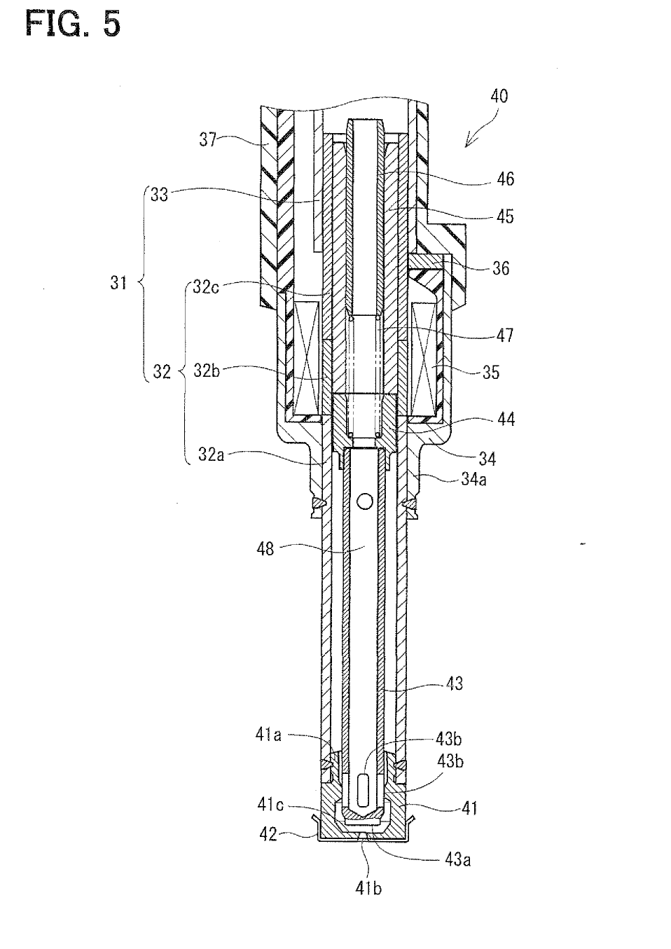

A third embodiment of the invention in which the laser welding method of the invention is applied to an injector will be described in reference to FIGS. 4A and 4B. A housing assembly 30 illustrated in FIGS. 4A and 4B is an intermediate product of the injector. A main feature of the injector, which is a finished product, will be described in reference to FIG. 5. An injector 40 is used for a fuel injection system for an internal combustion engine in an automobile, for example. The main part of the injector 40 is constituted of a guiding pipe 32, a coil 35, an injection nozzle 41, a valve member 43, a movable core 44, a fixed core 45, an adjusting pipe 46, a spring 47 and so forth.

The guiding pipe 32 is composed of a first magnetic portion 32a, a nonmagnetic portion 32b, and a second magnetic portion 32c. The first magnetic portion 32a, the nonmagnetic portion 32b, and the second magnetic portion 32c are arranged in this order from the lower side of FIG. 5. The first magnetic portion 32a and the second magnetic portion 32c constitute a magnetic circuit together with the movable core 44 and the fixed core 45. The nonmagnetic portion 32b prevents a short circuit of a magnetic flux between the first magnetic portion 32a and the second magnetic portions 32c. The coil 35 is disposed radially outward of the nonmagnetic portion 32b and the second magnetic portion 32c, and generates a magnetic field upon energization of the coil 35.

The injection nozzle 41 is provided at a leading end of the guiding pipe 32 (lower side in FIG. 5). The injection nozzle 41 is formed in a cylindrical shape having a bottom, includes a nozzle hole 41b at its front end. A nozzle hole plate 42 having a cup shape is fixed on an outer peripheral surface of the injection nozzle 41 by welding.

The valve member 43 is hollow in a cylindrical shape having a bottom. A front end surface 43a of the valve member 43 is engageable with a valve seat 41c formed on the bottom face of the injection nozzle 41. The valve member 43 includes a fuel hole 43b passing through its side wall. The fuel, which has flowed into the valve member 43, passes through the fuel hole 43b from the inside to outside of the valve member 43.

The movable core 44 is joined by welding, for example, to the valve member 43 on the opposite side of the member 43 from the injection nozzle 41, and the movable core 44 can reciprocate integrally with the valve member 43. The fixed core 45 is located on the opposite side of the movable core 44 from the injection nozzle 41. The fixed core 45 is fixed by welding or press fitting on an inner peripheral side of the nonmagnetic portion 32b and the second magnetic portion 32c of the guiding pipe 32.

One end of the spring 47 is in contact with the adjusting pipe 46, and the other end of the spring 47 is in contact with the movable core 44. The spring 47 urges the movable core 44 and the valve member 43 in a direction in which the valve member 43 is engaged with the valve seat 41c (i.e., downward in FIG. 5). By changing its setting position in the axial direction, the adjusting pipe 46 can adjust a load of the spring 47.

An operation of the injector 40 will be described. Upon energization of the coil 35, the movable core 44 is attracted to the fixed core 45. Accordingly, the valve member 43 is displaced upward in FIG. 5 integrally with the movable core 44 is disengaged from the valve seat 41c. FIG. 5 illustrates a valve-opening state of the injector 40. The fuel, which has flowed into a fuel passage 48 from an upper part of the injector 40 in FIG. 5, passes through the fuel hole 43b from the inner side of the valve member 43, and is injected through the nozzle hole 41b via a space between the front end surface 43a of the valve member 43 and the valve seat 41c. On the other hand, when the energization of the coil 35 is turned off, the valve member 43 is engaged with the valve seat 41c, so that the injector 40 is valve-closed. Accordingly, the fuel injection is cut off. The coil 35, the movable core 44, and the fixed core 45 may correspond to a “driving unit”.

Next, the explanation returns to the reference to FIGS. 4A and 4B to describe the housing assembly, to which the laser welding method of the invention is applied. The housing assembly 30 is made up of a pipe assembly 31, a holder 34, the coil 35, a housing plate 36, a resin molding part 37, an electric connector 38, and so forth.

The pipe assembly 31 is obtained by integrally forming the guiding pipe 32 and an inflow pipe 33. The guiding pipe 32 and the inflow pipe 33 are stainless-steel pipes having thickness of approximately 0.35 mm. The guiding pipe 32 is formed in a straight pipe shape, and has an outer diameter of approximately 6 mm, and an inner diameter of approximately 5.3 mm. The inflow pipe 33 has a fuel inflow-side end portion that is flared out. The guiding pipe 32 and the inflow pipe 33 constitute a passage for high pressure fuel. The guiding pipe 32, and the pipe assembly 31 including the guiding pipe 32 may correspond to a “fuel passage member”.

The holder 34 accommodates the coil 35 radially outward of the guiding pipe 32. A fitted part 34a of the holder 34 is fitted on an outer wall of the guiding pipe 32. An electric current, which is passed through the coil 35, is connected to a terminal 38a of the electric connector 38.

The pipe assembly 31, the holder 34, the coil 35, the housing plate 36, and the electric connector 38 are inserted into a die at the time of injection forming of the resin molding part 37 to be integrally formed. At a stage after this insert molding, the holder 34 and the guiding pipe 32 are only fitted together, and not joined yet.

Then, a “process for welding the holder 34 onto the guiding pipe 32” and a “process for welding the injection nozzle 41 to the leading end of the guiding pipe 32” are performed. As for the order of these welding processes at two places, either welding process may be performed first. In the third embodiment, an example, in which the “process for welding the injection nozzle 41 to the leading end of the guiding pipe 32” is performed first, will be described.

As illustrated in FIGS. 4A and 4B, first, the injection nozzle 41 is fitted into the guiding pipe 32. After that, the inert gas injection process and the welding process are carried out. A fitted part 41a of the injection nozzle 41 is fitted on an inner wall of the front end portion of the guiding pipe 32. The injection nozzle 41 includes the nozzle hole 41b at its front end. The injection nozzle 41 may correspond to the “covering member”.

In the inert gas injection process, inert gas G1 is injected from a gas injection nozzle 21 which is in contact with an opening of the inflow pipe 33 of the pipe assembly 31, and air G0 which has been inside the pipe assembly 31 is discharged from the nozzle hole 41b. Thus, the nozzle hole 41b of the injection nozzle 41 functions as the air vent of the covering member.

After the air inside the pipe assembly 31 has been replaced with the inert gas G1, an outer peripheral surface of the guiding pipe 32, which is the “irradiated side member”, is irradiated with a laser light L by a laser irradiation head 51 with the housing assembly 30 and the injection nozzle 41 rotated around their central axis; and metal is melted from the guiding pipe 32 into the fitted part 41a of the injection nozzle 41, which is the “melted side member”. Meanwhile, an energy value and irradiation time of the laser irradiation are adjusted such that a leading end of a weld penetration part 16 is located within thickness of the fitted part 41a.

Subsequently, similarly, an outer peripheral surface of the fitted part 34a of the holder 34, which is the “irradiated side member”, is irradiated with the laser light L by the laser irradiation head 51. Metal is melted from the fitted part 34a into the guiding pipe 32, which is the “melted side member”. Meanwhile, an energy value and irradiation time of the laser irradiation are adjusted such that the leading end of a weld penetration part 15 is located within thickness of the guiding pipe 32. The inert gas G1 continues to be injected from the inert gas injection process until after the welding process. The places welded in the welding process are cooled by the inert gas G1.

in the third embodiment, an effect similar to the first and second embodiments is produced. In the injector 40, high pressure fuel flows along the inside of the guiding pipe 32 and the injection nozzle 41. To reduce a flow resistance of the high pressure fuel, and to prevent incorporation of foreign substances, which have been exfoliated off the inner wall of the pipe 32 and nozzle 41 by the high-pressure fuel flow, into fuel, a high level of quality is required with respect to, for example, surface roughness of the inner wall. Therefore, if the laser welding method of the invention is applied to the housing assembly of the injector, a particularly great effect is produced. More specifically, in this case, the holder 34, which accommodates the coil 35, may correspond to the second pipe that is fitted and welded on the fuel passage member, which is the first pipe. A high level of quality is required with respect to, for example, surface roughness of the inner wall for the fuel passage member 32, 31 serving as the first pipe to reduce the flow resistance of high pressure fuel, and to prevent incorporation of foreign substances, which have been exfoliated off the inner wall by the high-pressure fuel flow, into fuel. Accordingly, if the laser welding method of the invention is applied to the fuel passage member of the injector, a particularly great effect is produced.

Moreover, in the housing assembly of the injector in accordance with the third embodiment, the inner wall of the guiding pipe 32 or the injection nozzle 41, which is the melted side member, is not burned or oxidized in the welding process; and the inner wall maintains metallic luster before the welding. Accordingly, through the observation of the inner wall of the guiding pipe 32 or the injection nozzle 41, determination of the injector which has been produced as a result of the application of the laser welding method of the invention, can be made. More specifically, in this injector 40, the inner wall of the fuel passage member 32, 31 maintain its metallic luster before welding. To “maintain the metallic luster before welding” means that there is no “burn” or discoloration due to oxidation. Particularly, the fuel passage member 32, 31 of this injector 40 is welded as the first pipe in the laser welding method of the invention. Accordingly, the temperature of the weld penetration part is stabilized; and the weld penetration depth can be accurately controlled such that the front end of the weld penetration part is located within the thickness of the fuel passage member 32, 31. Thus, the inner wall of the fuel passage member 32, 31 is not burned or oxidized. Hence, through the observation of the inner wall of the fuel passage member 32, 31, determination of the injector 40 which has been produced as a result of the application of the laser welding method of the invention, can be made. The laser welding method of the invention is applied to welding between the injection nozzle 41 that is provided at the front end of the injector 40, and the fuel passage member 32, 31 that is fitted radially outward of the injection nozzle 41. In this case, the injection nozzle 41 is equivalent to the first pipe, and the fuel passage member 32, 31 is equivalent to the second pipe. In this manner, even in the case of the injection nozzle 41 corresponding to the first pipe, a similar effect to the above is produced.

### Fourth Embodiment

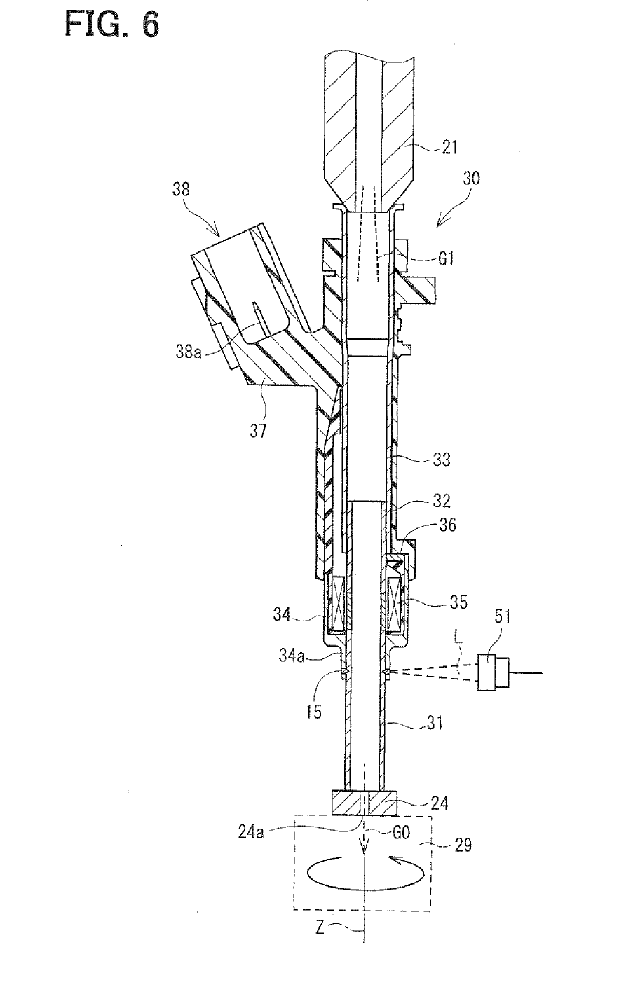

A fourth embodiment of the invention is another embodiment in which the laser welding method of the invention is applied to the injector. In the fourth embodiment, as illustrated in FIG. 6, a jig 24 for gas retention having an air vent 24a is in contact with a front end of a guiding pipe 32 of a housing assembly 30; and the inert gas injection process, and a “process for welding between a holder 34 and the guiding pipe 32” are carried out.

In this case, in the inert gas injection process, inert gas G1 is injected from a gas injection nozzle 21 which is in contact with an opening of an inflow pipe 33 of a pipe assembly 31, and air G0 which has been inside the pipe assembly 31 is discharged from the air vent 24a. Then, the process for welding between the holder 34 and the guiding pipe 32, and the cooling process are performed similar to the third embodiment. After the completion as the housing assembly 30 in this manner, a “process for welding between the guiding pipe 32 and an injection nozzle 41” is carried out in a separated process. In the fourth embodiment, an effect similar to the third embodiment is produced.

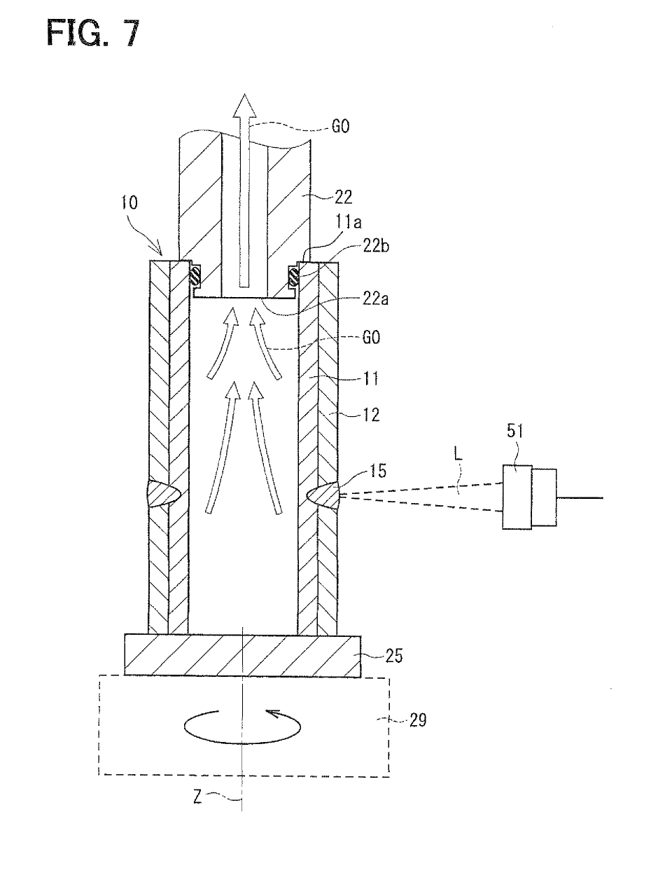

Modifications of the above-described embodiments will be described below. A laser welding method illustrated in FIG. 7 includes a low pressure welding process instead of the inert gas injection process and the welding process in the above-described embodiments. In the low pressure welding process, the inside of a first pipe 11 is made to have a pressure that is lower than the atmospheric pressure. In this embodiment, a vacuum nozzle 22 is attached to an opening 11a of the first pipe 11 at its upper end. The vacuum nozzle 22 is connected to a vacuum pump (not shown). The vacuum nozzle 22 includes an O ring 22b that is in contact with an inner wall of the first pipe 11 for the sake of air-tightness. An opening of the first pipe 11 at its lower end is covered by a covering jig 25.

The vacuum nozzle 22 suctions air G0 inside the first pipe 11 through the operation of the vacuum pump. As a result, the inside of the first pipe 11 has the pressure that is lower than the atmospheric pressure. Accordingly, the inside of the first pipe 11 is put into a “diluted oxygen state” in which oxygen concentration is lower than in the atmosphere, so that oxidation of the inner wall of the first pipe 11 can be limited. Therefore, the weld penetration depth can be adjusted more simply than the method for injecting the inert gas. The temperature of the welded place is promptly reduced in the cooling process, so that the oxidation of the inner wall of the first pipe can be more reliably prevented. In such a case, a cooling effect by inert gas G1 cannot be produced. Accordingly, coolant gas or the like may be used separately, or in the case of natural cooling, it is desirable that the “diluted oxygen state” should be maintained until the welded place is sufficiently cooled down.

In the embodiment including the inert gas injection process as well, the injection of inert gas G1 is not continued until after the welding process, and the welded place may be cooled by natural cooling. In the above embodiments, the inert gas G1 is injected from the upper direction into the pipe disposed in the vertical direction, and the pipe is irradiated with the laser light L in the horizontal direction. However, the direction of the injection of inert gas and direction of laser irradiation are not limited to this example. For example, a pipe disposed in the horizontal direction may be irradiated with a laser light from a direction perpendicular to an axis of the pipe.

In the above embodiments, the inert gas G1 is injected into the pipe placed in the atmosphere. In addition, for example, a pipe is placed in a room that is filled with inert gas by a transfer robot, and then the welding process may be performed. In this case, “placing the pipe in the room that is filled with the inert gas” itself may correspond to the “inert gas injection process”.

In the above embodiments, in the welding process, the laser irradiation head 51 is fixed, and the first pipe and the second pipe are rotated around the central axis. In addition, the laser irradiation head may rotate around the first pipe and the second pipe, which are fixed, and the welding process may be carried out. In addition to the embodiment in which the whole circumference of the pipe is evenly welded through the continuous irradiation of the laser light during the relative rotation between the first and second pipes, and the laser irradiation head, “spot welding” may be performed through intermittent irradiation.

The invention is not by any means limited to such embodiments, and may be embodied in various modes without departing from the scope of the invention.

Additional advantages and modifications will readily occur to those skilled in the art. The invention in its broader terms is therefore not limited to the specific details, representative apparatus, and illustrative examples shown and described.

What is claimed is:

1. A laser welding method for forming a pipe joint product, comprising:
providing a first pipe made of metal;
fitting a second pipe on a radially outward part of the first pipe, wherein the second pipe is made of metal;
performing an inert gas injection process, wherein the performing of the inert gas injection process includes:
injecting inert gas into an inside of the first pipe; and
discharging air in the inside of the first pipe into an outside of the first pipe; and
performing a welding process, wherein the performing of the welding process includes:
irradiating the second pipe with a laser from radially outward of the second pipe;
melting metal from the second pipe into the first pipe, with a weld penetration depth of a weld penetration part of the second pipe into the first pipe being adjusted such that a leading end of the penetration part is located within a thickness of the first pipe; and
welding together the first pipe and the second pipe along a circumferential direction thereof so as to form the pipe joint product.

2. The laser welding method according to claim 1, wherein:
the injecting of the inert gas includes injecting the inert gas from one end portion of the first pipe into the inside of the first pipe;
the performing of the inert gas injection process further includes bringing a covering member into contact with an end portion of one of the first pipe and the second pipe on an opposite side from the one end portion; and
the covering member is configured to limit an outflow of the inert gas.

3. The laser welding method according to claim 2, wherein the discharging of the air includes discharging the air through an air vent of the covering member in accordance with the injection of the inert gas.

4. The laser welding method according to claim 1, further comprising performing a cooling process, wherein the performing of the cooling process includes cooling welded places of the first pipe and the second pipe, which have been welded in the welding process.

5. The laser welding method according to claim 4, wherein the performing of the welding process further includes injecting the inert gas into the inside of the first pipe.

6. The laser welding method according to claim 5, wherein the inert gas injection process, the welding process, and the cooling process are performed in this order, the method further comprising continuously injecting the inert gas into the inside of the first pipe from the inert gas injection process to the cooling process.

7. The laser welding method according to claim 6, wherein temperature of the continuously injected inert gas is lower than atmospheric temperature.

8. A pipe joint product formed by the laser welding method according to claim 1, wherein an inner wall of the first pipe maintains its pre-welding metallic luster.

9. An injector adapted for a fuel injection system of an internal combustion engine, the injector comprising:
an injection nozzle that is configured to inject fuel;
a fuel passage member that defines a fuel passage communicating with the injection nozzle and that is welded as the first pipe by the laser welding method according to claim 1 to maintain pre-welding metallic luster on an inner wall of the fuel passage member;
a valve member that is accommodated in the fuel passage member to reciprocate therein so as to open or close the injection nozzle; and
a driving unit that is configured to drive the valve member.

10. A laser welding method for forming a pipe joint product, comprising:
providing a first pipe made of metal;
fitting a second pipe on a radially outward part of the first pipe, wherein the second pipe is made of metal; and
performing a low pressure welding process, wherein the performing of the low pressure welding process includes:
making a pressure of an inside of the first pipe lower than atmospheric pressure;
irradiating the second pipe with a laser from radially outward of the second pipe;
melting metal from the second pipe into the first pipe, with a weld penetration depth of a weld penetration part of the second pipe into the first pipe being adjusted such that a leading end of the penetration part is located within a thickness of the first pipe; and
welding together the first pipe and the second pipe along a circumferential direction thereof so as to form the pipe joint product.

11. The laser welding method according to claim 10, further comprising performing a cooling process, wherein the performing of the cooling process includes cooling welded places of the first pipe and the second pipe, which have been welded in the low pressure welding process.

12. A pipe joint product formed by the laser welding method according to claim 10, wherein an inner wall of the first pipe maintains its pre-welding metallic luster.

13. An injector adapted for a fuel injection system of an internal combustion engine, the injector comprising:
an injection nozzle that is configured to inject fuel;
a fuel passage member that defines a fuel passage communicating with the injection nozzle and that is welded as the first pipe by the laser welding method according to claim 10 to maintain pre-welding metallic luster on an inner wall of the fuel passage member;
a valve member that is accommodated in the fuel passage member to reciprocate therein so as to open or close the injection nozzle; and
a driving unit that is configured to drive the valve member.
